(19) United States
(12) Patent Application Publication
(10) Pub. No.: US 2010/0088446 A1
(43) Pub. Date: Apr. 8, 2010

(54) PRIORITIZING INTERRUPT CONTROLLER

(75) Inventors: Karl F. GREB, Missouri City, TX (US); Alexandre PALUS, Houston, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/347,792

(22) Filed: Dec. 31, 2008

Related U.S. Application Data
(60) Provisional application No. 61/103,046, filed on Oct. 6, 2008.

(51) Int. Cl. G06F 13/24

(52) U.S. Cl. 710/266

(57) ABSTRACT

A system comprises processing logic. The system also comprises a first interrupt controller coupled to the processing logic and configured to manage interrupts provided to the processing logic. The system further comprises a second interrupt controller coupled to the first interrupt controller. The second interrupt controller is programmable to distribute received interrupts to the first interrupt controller via different output ports.

### CROSS-REFERENCE TO RELATED APPLICATIONS

This application claims the benefit of U.S. Provisional Application Ser. No. 61/103,046, filed Oct. 6, 2008, titled “Vectored Interrupt Controller for ARM v7M Processors,” and incorporated herein by reference as if reproduced in full below.

### BACKGROUND

An interrupt is an event that causes a processor to temporarily cease what it is doing so that it may attend to a condition associated with that event. Processors often contain and/or couple to interrupt controllers that manage interrupts for the processors. For example, when an interrupt controller receives multiple interrupts at or about the same time, the interrupt controller prioritizes the interrupts and provides the interrupts to its processor accordingly. Many interrupt controllers are inflexible in regard to the number of interrupts that they can handle at a given time.

### SUMMARY

The problems noted above are solved in large part by an interrupt controller that is located external to processing logic and that is able to prioritize interrupt request signals. An illustrative embodiment includes a system that comprises processing logic. The system also comprises a first interrupt controller coupled to the processing logic and configured to manage interrupts provided to the processing logic. The system further comprises a second interrupt controller coupled to the first interrupt controller. The second interrupt controller is programmable to distribute received interrupts to the first interrupt controller via different output ports.

Another illustrative embodiment includes an interrupt controller that comprises multiple input ports configured to receive interrupt requests. The controller also includes multiple, enabled output ports. The output ports are fewer in number than the input ports. The interrupt controller dynamically assigns at least some of the multiple input ports to the multiple output ports.

Yet another illustrative embodiment includes a method that comprises an interrupt controller receiving an interrupt request on an input port and providing the interrupt request to an output port. The method also comprises the interrupt controller re-assigning the input port to another output port. The method further comprises the interrupt controller receiving another interrupt request on the input port and providing the another interrupt request to the another output port.

### BRIEF DESCRIPTION OF THE DRAWINGS

For a detailed description of exemplary embodiments of the invention, reference will now be made to the accompanying drawings in which:

FIG. 1 shows a block diagram of an illustrative interrupt system, in accordance with various embodiments;

FIG. 2 shows a detailed view of the external interrupt controller (IC) of FIG. 1, in accordance with preferred embodiments;

FIG. 3 shows another detailed view of the external IC of FIG. 1, in accordance with various embodiments;

FIG. 4 shows yet another detailed view of the external IC of FIG. 1, in accordance with various embodiments;

FIG. 5a shows an illustrative circuit logic that is usable to block or regulate interrupt requests, in accordance with embodiments;

FIG. 5b shows illustrative circuit logic usable in conjunction with the circuit logic of FIG. 5a, in accordance with embodiments; and

FIG. 6 shows a flow diagram of an illustrative method implemented in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The terms “processor” and “processing logic” are analogous.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is an interrupt controller that is external to an associated processor. This interrupt controller, hereinafter referred to as an “external interrupt controller,” or “external IC,” interfaces with an interrupt controller internal to the processor (“internal interrupt controller,” or “internal IC”). The external IC is capable of receiving more input interrupt requests at a time than is the internal IC. The external IC can be programmed to manage the received interrupt requests and provide them to the internal IC as desired. In this way, the external IC affords greater flexibility to the processor and the internal IC with which the processor is associated.

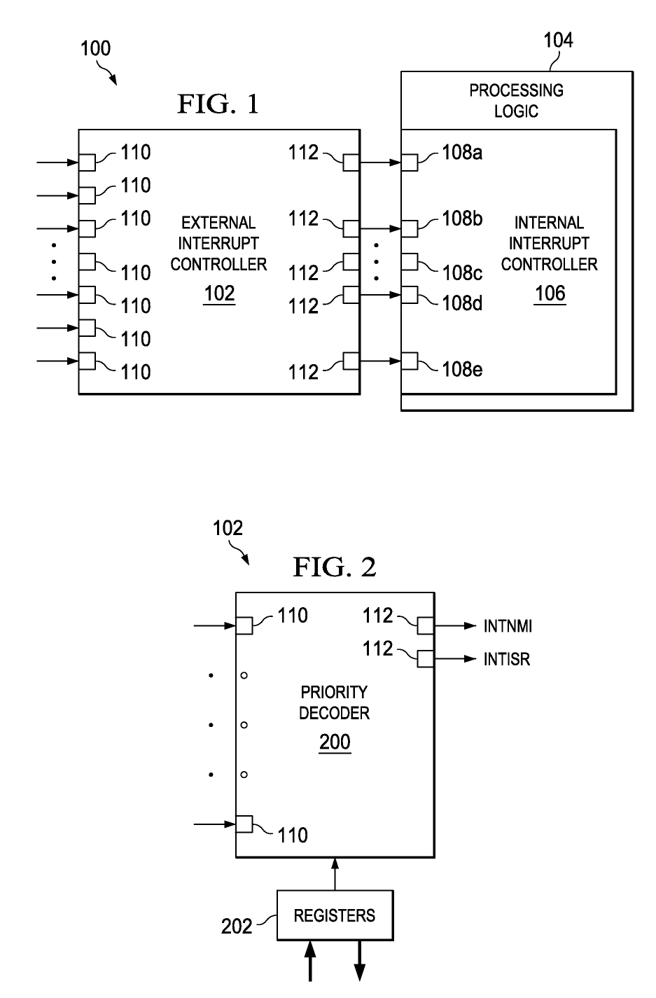

FIG. 1 shows a block diagram of an illustrative interrupt system 100, in accordance with various embodiments. The system 100 comprises an external IC 102 and processing logic 104 which, in turn, comprises internal IC 106. The internal IC 106 is a traditional interrupt controller that is housed within the processing logic 104 and that manages interrupts received by the processing logic 104. As shown, the internal IC 106 has a relatively limited number (e.g., 8) of input ports 108 through which the internal IC 106 receives interrupt requests. In contrast, the external IC 102, which is located outside of the processing logic 104, has a greater number (e.g., 16, 32, 48, 64, 128, 256, etc.) of input ports 110 than does the internal IC 106. In some embodiments, the external IC 102 has a number of output ports 112 (i.e., enabled and/or non-enabled) that is less than or equal to the number of input ports 110. The external IC 102 comprises programmable logic that dynamically routes interrupt requests received on input ports 110 to output ports 112. Thus, in some embodiments, interrupt request A may be routed from one input port 110 to an output port 112, while interrupt request B may be routed from a different input port 110 to the same output port 112. In other interrupt request A may be routed from one input port 110 to an output port 112, while interrupt request B may be routed from the same input port 110 to a different output port 112. Any number of such variations is possible and included within the scope of disclosure, given the fact that the external IC 102 is programmable and can be adjusted so that virtually any input port(s) 110 can couple to any output port(s) 112.

As described herein, the external IC 102 prioritizes interrupt requests received on its input ports 110. The manner in which the external IC 102 provides these interrupt requests to the internal IC 106 dictates the priority given to each interrupt request. In some embodiments, an interrupt request received on input port 108a of internal IC 106 is given the highest priority; a request received on input port 108b is given next-highest priority, and so forth, while an interrupt request received on input port 108e is given lowest priority. Thus, by adjusting how input ports 110 are mapped to output ports 112, the priority given to each interrupt request received by the external IC 102 may be manipulated.

FIG. 2 shows a detailed view of the external IC 102 of FIG. 1, in accordance with preferred embodiments. The external IC 102 comprises a priority decoder 200 and registers 202. The decoder 200 comprises input ports 110 and output ports 112. The decoder 200 uses information stored in the registers 202 to route signals received on input ports 110 to the appropriate output ports 112. Because the registers 202 dictate how the priority decoder 200 routes/distributes received interrupt request signals, programming and re-programming the registers 202 enables the priority decoder 200 to dynamically route/distribute the interrupt requests. Thus, for example, the registers 202 may be programmed so that the circuit logic in the priority decoder 200 routes an interrupt request signal received on an input port 110 to an output port 112. The registers 202 may then be re-programmed so that the circuit logic in the priority decoder 200 routes another interrupt request signal received on the same input port 110 to a different output port 112. Alternatively, or in addition, the registers 202 may be re-programmed so that the circuit logic in the priority decoder 200 routes additional interrupt request signals received on the same input port 110 and another input port 110 to a common output port 112. Any and all such permutations and variations are encompassed within the scope of this disclosure.

The registers 202 may be programmed in any suitable manner. In at least some embodiments, each output port 112 is associated with a register (e.g., a 7-bit register) 202. The input port 110 to which the output port 112 maps is determined by its associated register 202. Thus, for example, altering this register 202 can cause the associated output port 112 to map to a different input port 110.

Interrupt request signals output on the output ports 112 may be categorized in multiple ways. Two of these categories include the INTNMI interrupt request signal and the INTISR interrupt request signal. In at least some embodiments, the INTNMI interrupt request signals are consistently given priority over INTISR interrupt request signals. Thus, even the highest-priority INTISR interrupt request signal has a lower priority than any INTNMI interrupt request signal. Whether a received interrupt signal is categorized as an INTNMI interrupt request signal or an INTISR interrupt request signal depends on how the registers 202 are programmed. In at least some embodiments, some of the output ports 112 (e.g., the first two output ports 112) are dedicated to providing the high-priority INTNMI interrupt request signals, while the remaining output ports 112 are for providing INTNMI signals, INTISR signals and/or other types of interrupt request signals.

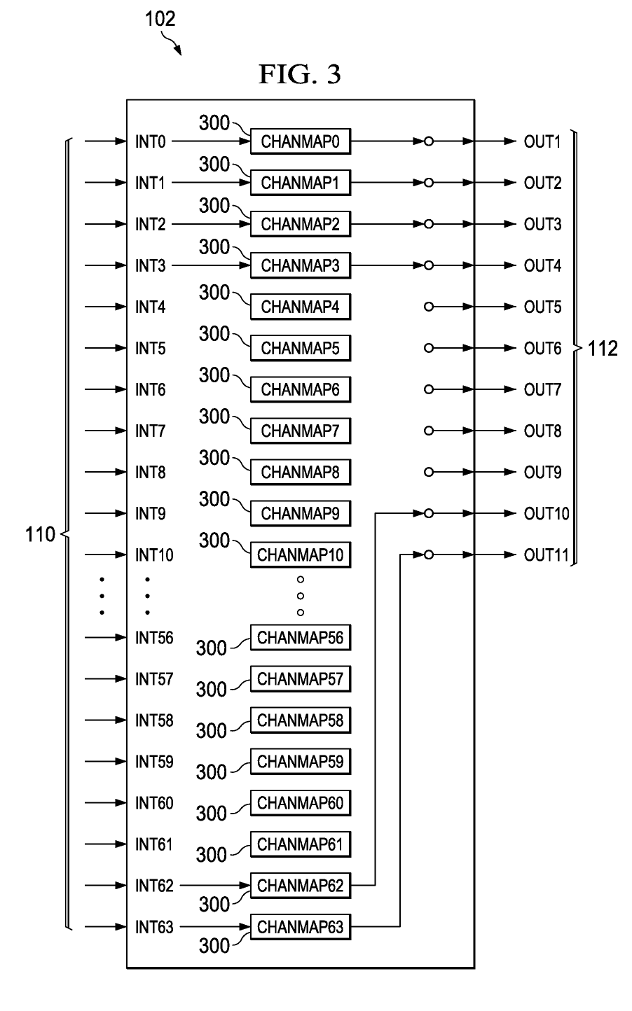

FIG. 3 shows another detailed view of the external IC 102, in accordance with various embodiments. The external IC 102 comprises 64 input ports 110 and 11 output ports 112, although, as previously explained, the other embodiments may have different numbers of input and output ports. Blocks 300 are conceptual and represent the registers 202 (described in FIG. 2) that determine the input ports 110 to which the output ports 112 will be mapped. Thus, for example, the block 300 that reads “CHANMAP0” represents a register 202 comprising bits that cause circuit logic in the external IC 102 to map the input port 110 “INT0” to the output port 112 “OUT1.” Similarly, the block 300 that reads “CHANMAP1” represents a register 202 comprising bits that cause circuit logic in the external IC 102 to map the input port 110 “INT1” to the output port 112 “OUT2.” Likewise, the block 300 that reads “CHANMAP63” represents a register 202 comprising bits that cause circuit logic in the external IC 102 to map the input port 110 “INT63” to the output port 112 “OUT11.” Circuit logic contained in the external IC 102 (e.g., AND gates, OR gates, NOR gates and/or XOR gates, etc.) receive signals from the registers 202 that cause the circuit logic to dynamically map input ports 110 to output ports 112 in accordance with the registers' contents.

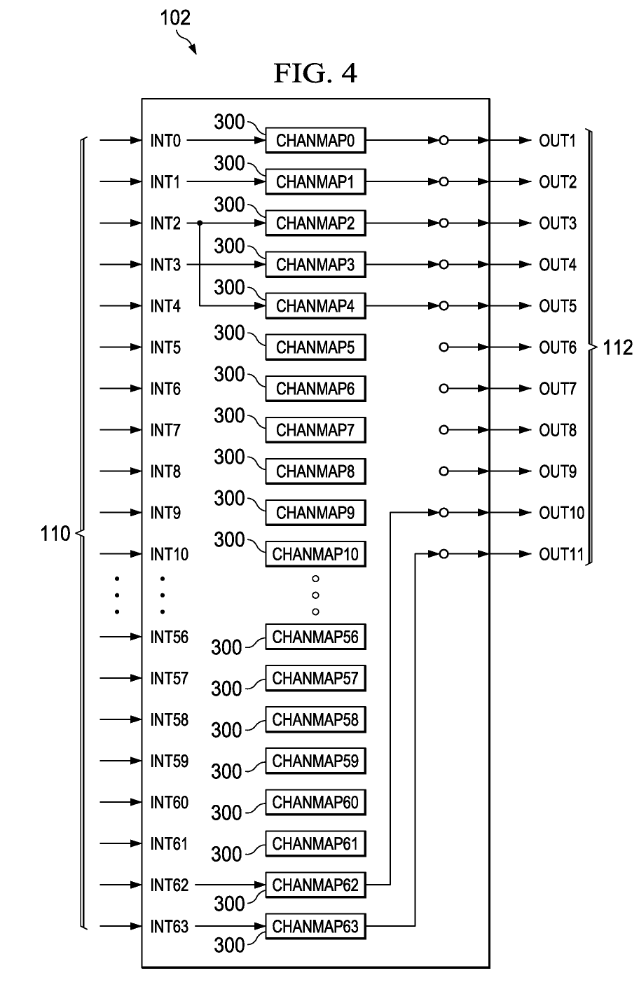

FIG. 4 shows yet another detailed view of the external IC 102, in accordance with various embodiments. The external IC 102 as shown in FIG. 4 is similar to that shown in FIG. 3. However, the external IC 102, as shown in FIG. 4, has been re-programmed so that the input port 110 “INT2” maps to output ports 112 “OUT3” and “OUT5.” The other input ports 110 and output ports 112 remain mapped as shown in FIG. 3. The “OUT3” and “OUT5” output ports 112 are re-mapped to a common input port 110 “INT2” because the registers 202 associated with “OUT3” and “OUT5” were re-programmed to correspond to “INT2.”

A comparison of FIGS. 3 and 4 illustrates how interrupt request priority levels can be dynamically manipulated by adjusting the registers 202. Refer now to both FIGS. 3 and 4. As previously explained, a difference between the external IC 102 as shown in FIG. 3 and as shown in FIG. 4 is that in FIG. 4, the external IC 102 has an input port 110 “INT2” that is mapped to two output ports 112 “OUT3” and “OUT5.” The circuit logic contained in the external IC 102 has the ability to enable and disable various input ports 110 and output ports 112 (e.g., by programming registers 202 accordingly or using any other suitable technique for enabling/disabling ports). Thus, referring to FIG. 3, when no port is disabled, the priority scheme achieved is as follows (from highest priority to lowest priority): INT0, INT1, INT2, INT3, . . . . Still referring to FIG. 3, when output port 112 “OUT3” is disabled, the priority scheme achieved is as follows: INT0, INT1, INT3, . . . . Referring to FIG. 4, when no port is disabled, the priority scheme achieved is as follows: INT0, INT1, INT2, INT3, . . . . Still referring to FIG. 4, when output port 112 “OUT3” is disabled, the priority scheme achieved is as follows: INT0, INT1, INT3, INT2, . . . . The manipulated mappings shown in FIG. 4 are achieved by adjusting the contents of one or more registers 202, as explained above. Thus, by adjusting the contents of one or more of the registers 202, the priority levels given to various interrupt request signals processed by the external IC 102 also are adjusted.

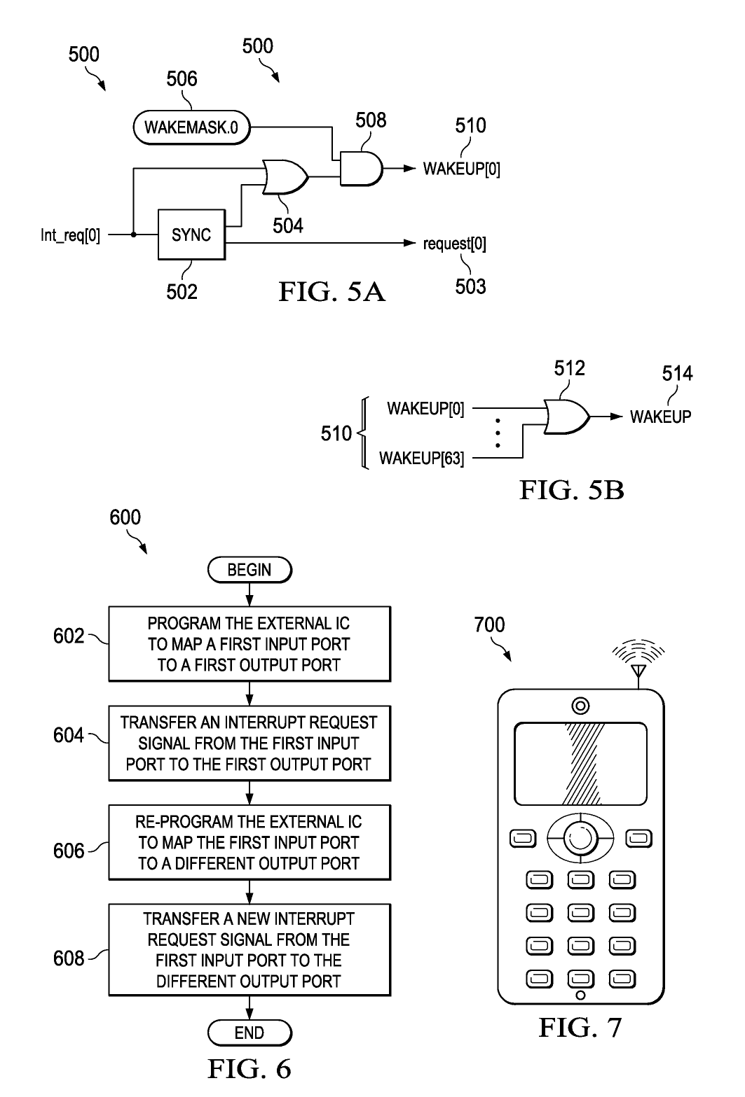

As described, the external IC 102 comprises various types of circuit logic that map different input ports 110 to different output ports 112. In some embodiments, the external IC 102 also comprises additional circuit logic that masks none, some or all of the interrupt request signals that pass through the external IC 102. This masking feature is usable, e.g., to block or regulate certain types of interrupt signals, such as wakeup interrupt signals sent from a peripheral device to the processing logic 104 via the external IC 102. FIG. 5a shows an illustrative circuit logic 500 that is usable to block or regulate certain interrupt requests. An interrupt request signal (e.g., INT0) is received on an input port 110. The request signal is synchronized with an input clock at block 502 and is output as request signal 503. The signal 503 is then provided to the rest of the external IC 102 logic that is used to map input ports to output ports and is processed as described above. However, an OR gate 504 receives a copy of the synchronized interrupt request signal and a copy of the non-synchronized interrupt request signal. In turn, the OR gate 504 outputs a signal to an AND gate 508, which also receives a mask bit 506 from the multi-bit mask applied to all the input ports 110. The mask bit 506 is the part of the multi-bit mask that applies to the INT0 input port 110. The AND gate 508 receives the mask bit 506 and the output of the AND gate 504 and produces an output signal 510. In the present example, the multi-bit mask is a signal used to mask “wakeup” interrupt signals that are intended to wake the processing logic 104 from a low-power (“sleep”) mode. Thus, the mask bit 506 is labeled “WAKEMASK.0” and the output of the AND gate 508 is labeled “WAKEUP[0].” This signal produced by the AND gate 508 enables or disables (i.e., unblocks or blocks) the interrupt signal 503.

Because the multi-bit mask is applied across all input ports 110, a plurality of output WAKEUP[x] signals are produced using logic similar to circuit logic 500. As shown in FIG. 5b, in an external IC 102 comprising 64 input ports 110, 64 WAKEUP[x] signals are all provided to an OR gate 512. If any of the WAKEUP[x] signals is asserted, then a single WAKEUP signal 514 is provided to the rest of the circuit logic of the external IC 102 so that the processing logic 104 is provided with the appropriate interrupt request signal. The circuit logic shown in FIGS. 5a-5b is merely illustrative of one possible use of masks that are applied to signals on input ports 110 in the external IC 102. All permutations and variations of such masking techniques are included within the scope of this disclosure.

FIG. 6 shows a flow diagram of an illustrative method 600 implemented in accordance with various embodiments. The method 600 begins by programming the external IC 102 to mapping a first input port 110 to a first output port 112 (block 602). The method 600 continues by transferring an interrupt request signal from the first input port 110 to the first output port 112 (block 604). The method 600 further continues by re-programming the external IC 102 to map the first input port 110 to a different output port 112 (block 606). The method 600 further continues by transferring a new interrupt request signal from the first input port 110 to the different output port 112 (block 608). The steps of the method 600 may be adjusted as desired to include additional steps, remove steps or re-arrange steps in a different order. As explained above, the input port-to-output port mappings may be dynamically altered as desired, so the method 600 may be adjusted in accordance with such mapping alterations.

FIG. 7 shows an illustrative mobile communication device 700 that stores the system 100 shown in and/or described with reference to FIGS. 1-6. The mobile communication device 700 may include, for example, a cell phone, a notebook computer, a portable multimedia player, a personal digital assistant, etc.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
processing logic;
a first interrupt controller coupled to the processing logic and configured to manage interrupts provided to the processing logic; and
a second interrupt controller coupled to the first interrupt controller;
wherein the second interrupt controller is programmable to distribute received interrupts to the first interrupt controller via different output ports.

2. The system of claim 1, wherein the second interrupt controller prioritizes said interrupts for said distribution.

3. The system of claim 1, wherein the second interrupt controller is disposed external to the processing logic and the first interrupt controller is contained within the processing logic.

4. The system of claim 1, wherein the second interrupt controller comprises X input ports and Y output ports, wherein the first interrupt controller comprises Y input ports, and wherein X is greater than Y.

5. The system of claim 1, wherein the system comprises a wireless communication device.

6. The system of claim 1, wherein the second interrupt controller maps one of its input ports to two of its output ports.

7. The system of claim 1, wherein the second interrupt controller comprises at least one output port that couples to an input port of the first interrupt controller and that is dedicated to transferring interrupt requests of a higher priority than requests transferred by other output ports.

8. An interrupt controller, comprising:
multiple input ports configured to receive interrupt requests; and
multiple, enabled output ports, said output ports fewer in number than said input ports;
wherein the interrupt controller dynamically assigns at least some of said multiple input ports to said multiple output ports.

9. The interrupt controller of claim 8, wherein the interrupt controller is programmable to assign an input port to an output port and to subsequently re-assign the input port to a different output port.

10. The interrupt controller of claim 8, wherein the interrupt controller prioritizes interrupt requests received via the multiple input ports and outputs the interrupt requests on the multiple output ports in accordance with said prioritization.

11. The interrupt controller of claim 8, wherein the interrupt controller is housed within a device selected from the group consisting of a cell phone, a personal digital assistant, a portable multimedia device and a notebook computer.

12. The interrupt controller of claim 8, wherein the interrupt controller is external to a processor that receives interrupt requests provided to said multiple output ports.

13. The interrupt controller of claim 8, wherein the interrupt controller maps one of its input ports to more than one of its output ports.

14. The interrupt controller of claim 8, wherein at least two of the output ports are dedicated to servicing interrupt requests that are of a higher priority than interrupt requests serviced using other output ports.

15. A method, comprising:
an interrupt controller receiving an interrupt request on an input port and providing said interrupt request to an output port;
the interrupt controller re-assigning said input port to another output port; and
the interrupt controller receiving another interrupt request on the input port and providing said another interrupt request to the another output port.

16. The method of claim 15, further comprising re-assigning said input port to multiple output ports.

17. The method of claim 15, wherein the interrupt controller comprises a greater number of input ports than output ports.

18. The method of claim 15, wherein re-assigning said input port comprises dynamically re-assigning said input port using software commands.

19. The method of claim 15, further comprising prioritizing interrupt requests received on said input port and outputting said interrupt requests in accordance with said prioritization.

20. The method of claim 15, further comprising incorporating said interrupt controller into a mobile communication device.
